(19) United States
(12) Patent Application Publication
(10) Pub. No.: US 2013/0044257 A1
(43) Pub. Date: Feb. 21, 2013

(54) MOBILE DEVICE WITH SIDE-MOUNTED CAMERA MODULE

(71) Applicants: Ta-Yi Chien, Taipei (TW); Hai-Yin Hsu, Taipei (TW); Kuan-Yu Chen, Taipei (TW); Fen-Ling Hu, Taipei (TW); Wei-Yu Lee, Taipei (TW); Kun-Yi Lee, Taipei (TW); Yen-Juei Lin, Taipei (TW); Chien-Chun Chen, Taipei (TW); Chien-Hsun Kao, Taipei (TW); Min-Han Lin, Taipei (TW); Chia-Yu Guo, Taipei (TW); Shih-Han Tseng, Taipei (TW); Chin-Yu Chang, Taipei (TW)

(72) Inventors: Ta-Yi Chien, Taipei (TW); Hai-Yin Hsu, Taipei (TW); Kuan-Yu Chen, Taipei (TW); Fen-Ling Hu, Taipei (TW); Wei-Yu Lee, Taipei (TW); Kun-Yi Lee, Taipei (TW); Yen-Juei Lin, Taipei (TW); Chien-Chun Chen, Taipei (TW); Chien-Hsun Kao, Taipei (TW); Min-Han Lin, Taipei (TW); Chia-Yu Guo, Taipei (TW); Shih-Han Tseng, Taipei (TW); Chin-Yu Chang, Taipei (TW)

(73) Assignee: LATTICE ENERGY TECHNOLOGY CORPORATION, Taipei (TW)

(21) Appl. No.: 13/588,947

(22) Filed: Aug. 17, 2012

Related U.S. Application Data
(60) Provisional application No. 61/524,804, filed on Aug. 18, 2011.

(51) Int. Cl. H04N 5/225

(52) U.S. Cl. 348/373; 348/E05.025

(57) ABSTRACT

The present disclosure relates to a mobile device provided with a camera module that is detachably received in a side of the device body. Particularly, the camera module is hidden inside the device body when not in use and can be drawn out from the side of the device body when in use. Since the camera module is not affixed permanently to the device, the detachable camera module can be used in small confined areas with expanded photo-capturing scope and angle.

### CROSS REFERENCE TO RELATED APPLICATION

This application claims priority to U.S. Provisional Application No. 61/524,804 filed on Aug. 18, 2011, the entire content of which is incorporated herein by reference.

### TECHNICAL FIELD

The present disclosure relates to a mobile device with side-mounted camera module, and more particularly, to a mobile device provided with a camera module that is detachably received in a side of the device body for allowing the detachable camera module to be drawn out of the mobile device and used in small confined areas with expanded photo-capturing scope and angle as the camera module is not affixed permanently to the device.

### TECHNICAL BACKGROUND

Conventionally, mobile devices whichever are configured with camera lenses are designed to have the camera lenses to be located either at the front or the back of the device bodies. By affixing the camera in the front or the back of the device body, users are enabled to see the display of the mobile device while shooting a photo.

In order to be able to place the camera lens in the front or the back of the device, the camera lens must be made thinner than the thickness of the device body so that it can properly fit inside the device. However, since demands for thinner and lighter mobile device with more sophisticated camera module have risen significantly, the challenge is to make such camera module sufficiently thin so as to be packaged inside a device body.

Nevertheless, exceptionally thin camera modules with high resolution capabilities are expensive and difficult to make, not to mention that having lens affixed either in the front or the back of the device body can restricts the angle in which a user can point the camera. Thus, it is in need of a mobile device with side-mounted camera module that is freed from the abovementioned shortcomings.

### TECHNICAL SUMMARY

In view of the disadvantages of prior art, the primary object of the present invention is to provide a mobile device provided with a camera module that is detachably received in a side of the device body for allowing the detachable camera module to be drawn out of the mobile device and used in small confined areas with expanded photo-capturing scope and angle as the camera module is not affixed permanently to the device. Specifically, since the camera module can be received in a slot or a groove that goes through the side of the device body, the camera module does not have to be made thinner than the thickness of the mobile device so that the cost and difficulty in making the camera module are reduced significantly.

To achieve the above object, the present invention provides a mobile device, comprising:
a device body;
a housing structure, formed on one side selected from the device body;
a camera module, detachably received in the selected side of the device body by the housing structure while being electrically connected to the mobile device.

In an embodiment of the present invention, the mobile device can be a cellular phone, a laptop computer, a tablet computer, a monitor, or a personal digital assistant.

In another embodiment of the present invention, the camera module is electrically connected to the mobile device via a wire or a wireless connection.

In another embodiment of the present invention, the wireless connection can be a connection selected from the group consisting of: a Bluetooth connection, an infrared connection and the like.

In another embodiment of the present invention, the housing structure is substantially a slot formed on the selected side of the device body in a width and length suitable for the camera module to be housed therein.

In another embodiment of the present invention, the slot is made either vertically or horizontally by one side of the device body.

In another embodiment of the present invention, there is no limit to the size of the slot in width or in length only if the slot is suitable for housing the camera module therein.

In another embodiment of the present invention, the camera module that is able to connect wirelessly to the mobile device is further equipped with an ability to attached itself onto any sides of the mobile device in addition to the selected side.

In another embodiment of the present invention, the camera module is designed to be made into a device selected from the group consisting of: a recorder, a scanner, a video camera and a projector.

In another embodiment of the present invention, the camera module is further consisted of a plurality of cameras, each capable of working independently for capturing different images.

In another embodiment of the present invention, since the size of the camera module is not restricted by the thickness of the mobile device, the detachable camera module is further being configured with at least one additional component.

In another embodiment of the present invention, each of the at least one addition component is a component selected from the group consisting of: a flash light, a speaker, a microphone, a tripod.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A is a schematic diagram showing a mobile device with detachable camera module received inside the mobile device according to an embodiment of the present invention.

FIG. 1B is a schematic diagram showing the mobile device of FIG. 1A with its detachable camera module being drawn out of the mobile device.

FIG. 2 is a schematic diagram showing the detachable camera module of FIG. 1A that is attached onto the right side of the mobile device.

FIG. 3 is a schematic diagram showing a mobile device according to another embodiment of the present invention where the camera module incorporates a projectile function.

FIG. 4 is a schematic diagram showing a mobile device according to another embodiment of the present invention where the camera module incorporates a scanning function.

FIG. 5 is another embodiment of the present invention where the mobile device is a monitor and the camera module is received in a side of the monitor.

FIG. 6 shows the monitor of FIG. 5 with its detachable camera module being drawn out for imaging.

### DESCRIPTION OF THE EXEMPLARY EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

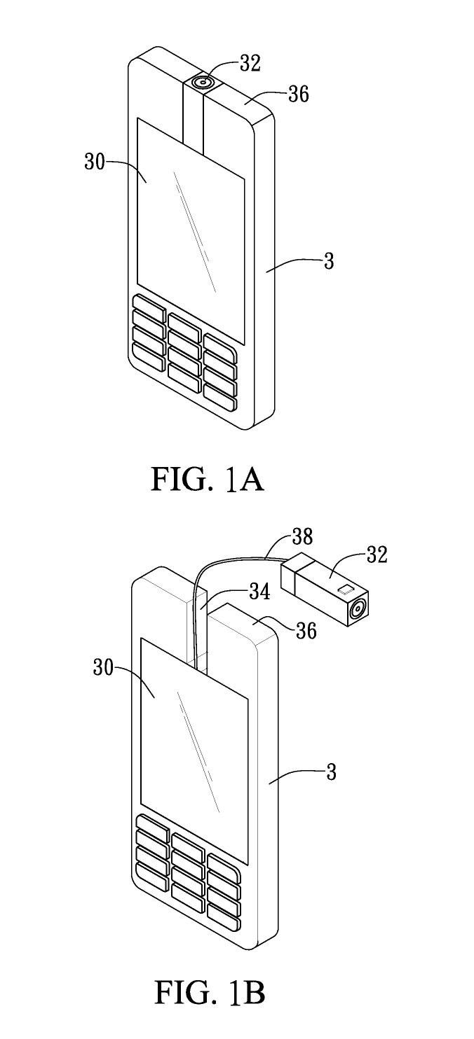

The present invention provides a mobile device that is formed with a housing structure at a side of its device body to be used for receiving a detachable camera module therein, by that the detachable camera module does not have to be made thinner than the thickness of the mobile and can be selectively drawn out from the housing structure when in use. Thereby, the cost and difficulty in the making of the camera module can be reduced significantly. Please refer to FIG. 1A and FIG. 1B, which shows one way a detachable camera module is received in a selected side of the mobile device according to an embodiment of the invention. In this embodiment shown in FIG. 1A and FIG. 1B, the mobile device 3 is a cellular phone, and the housing structure 34 is substantially a slot 34 formed on the top side 36 of the device body 30 of the mobile device 3 for receiving a detachable camera module 32. It is noted that the mobile device 3 is not limited to be a cellular phone, as the one shown in the foregoing embodiment, and thus it can be a laptop computer, a tablet computer, a monitor, or a personal digital assistant, etc. In addition, the slot 34 can be formed either vertically or horizontally by one side of the device body 30, and also there is no limit to the size or shape of the slot 34 so long as it can properly house the camera module 32 therein. Operationally, the camera module 32 can be drawn out of the slot 34 while allowing the detachable camera module 32 to be connected to the mobile device 3 either via a wire, or via any wireless connection available, such as infrared or Bluetooth. In the present embodiment, the camera module 32 is connected to the mobile device 3 via a wire 38; and the detachable camera module 32 only has to be made smaller than either the length or the width of the device body 30 to fit.

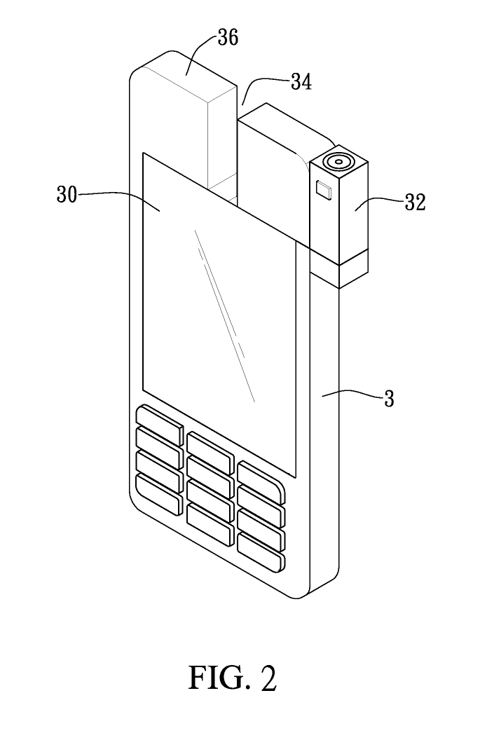

Please refer to FIG. 2, which is a schematic diagram showing the detachable camera module of FIG. 1A being attached onto the right side of the mobile device. As shown in FIG. 2, the camera module 32 that is able to connect wirelessly to the mobile device 3 is further equipped with an ability to attach itself onto any sides of the mobile device 3 in addition to the selected top side 36 where the housing structure 34 is formed. Operationally, the camera module 32 that can be drawn out of the slot 34 and can be attach to any side of the mobile device 3 when in use is a very user friendly tool as it can operate smoothly in any orientation desired by users.

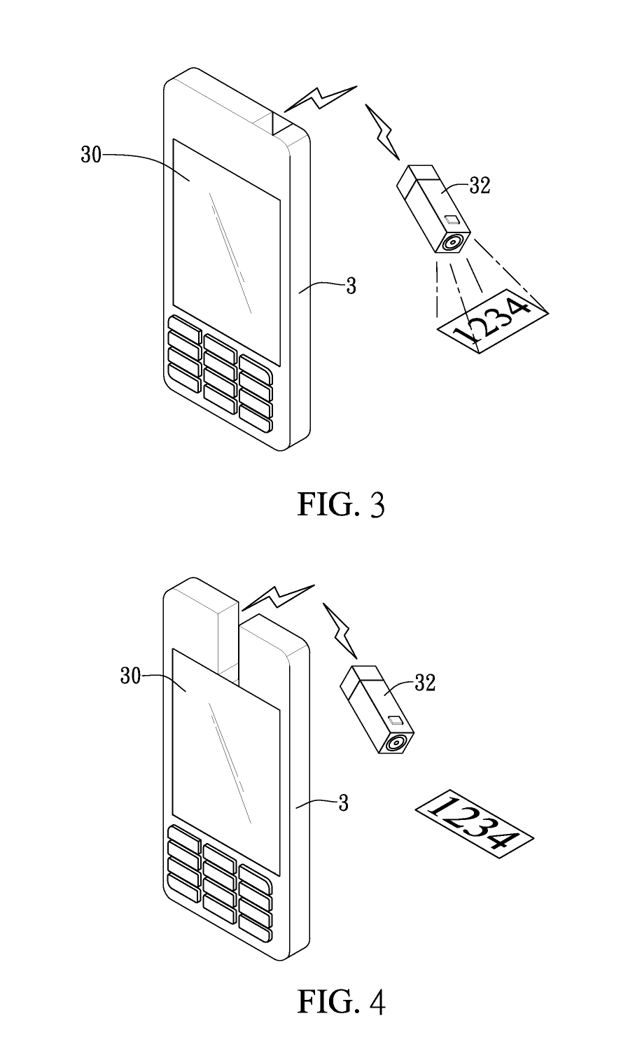

In addition, since the size of the camera 32 is not restricted by the thickness of the device body 30 of the mobile device 3, additional components, such as flash light, speakers, microphone and/or tripod, can be incorporated in the detachable camera module 32. Moreover, the detachable camera module 32 can be made into a recorder, a scanner, a video camera or even a projector, as the embodiments shown in FIG. 3 and FIG. 4.

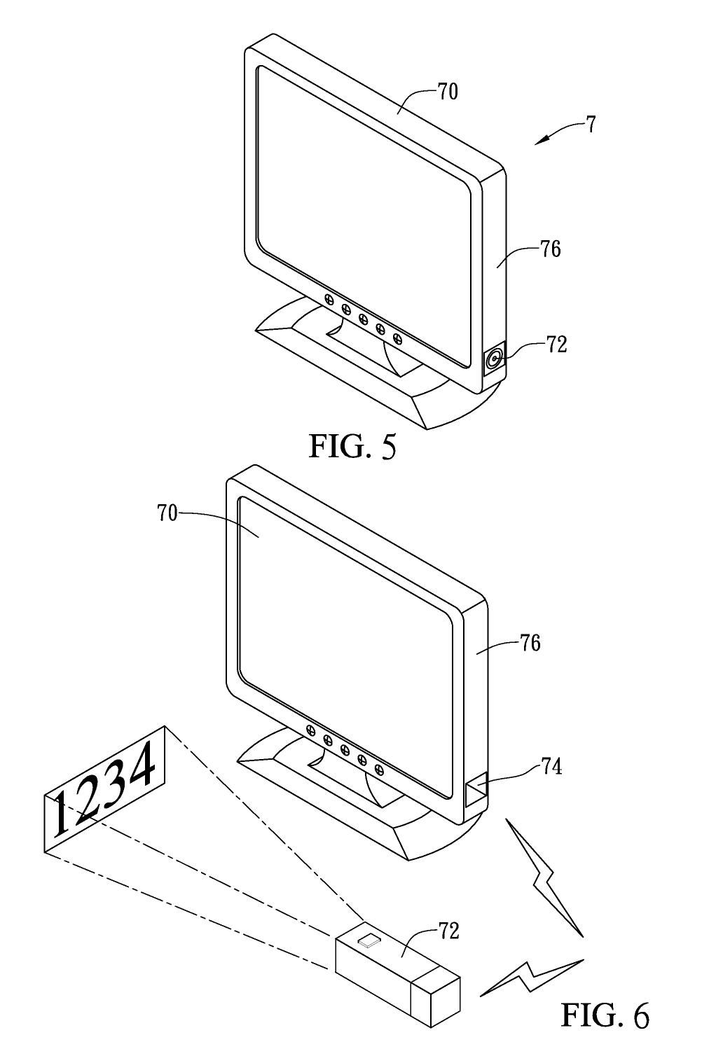

FIG. 5 is another embodiment of the invention. As shown in FIG. 5, the mobile device 7 is a monitor and the detachable camera module 72 is received in the housing structure 74 formed on the right side 76 of the monitor's body 70. In this embodiment, except for the camera module can be configured and operate the same as the one described in the abovementioned embodiments, it can further be composed of a plurality of cameras, while allowing each camera to work independently and simultaneously for capturing different images. Thereby, in addition to be used for capturing 3D images, if the camera module 72 with a plurality of cameras is incorporated with a projection function, such projector is able to project 3D images, as shown in FIG. 6.

To sum up, the present invention provides a mobile device having a camera module that is detachably received in a side of the device body for allowing the detachable camera module to be drawn out of the mobile device and used in small confined areas with expanded photo-capturing scope and angle as the camera module is not affixed permanently to the device. Specifically, since the camera module can be received in a slot or a groove that goes through the side of the device body, the camera module does not have to be made thinner than the thickness of the mobile device so that the cost and difficulty in making the camera module are reduced significantly.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A mobile device, comprising:
a device body;
a housing structure, formed on one side selected from the device body;
a camera module, detachably received in the selected side of the device body by the housing structure while being electrically connected to the mobile device.

2. The mobile device of claim 1, wherein the mobile device is a device selected from the group consisting of: a cellular phone, a laptop computer, a tablet computer, a monitor, and a personal digital assistant.

3. The mobile device of claim 1, wherein the camera module is electrically connected to the mobile device via a wired connection means or a wireless connection.

4. The mobile device of claim 3, wherein the wireless connection is a connection selected from the group consisting of: a Bluetooth connection, an infrared connection and the like.

5. The mobile device of claim 1, wherein the housing structure is substantially a slot formed on the selected side of the device body in a width and length suitable for the camera module to be housed therein.

6. The mobile device of claim 5, wherein the slot is made either vertically or horizontally by one side of the device body.

7. The mobile device of claim 5, wherein there is no limit to the size of the slot in width or in length only if the slot is suitable for housing the camera module therein.

8. The mobile device of claim 1, wherein the camera module that is able to connect wirelessly to the mobile device is further equipped with an ability to attach itself onto any sides of the mobile device in addition to the selected side.

9. The mobile device of claim 1, wherein the camera module is designed to be made into a device selected from the group consisting of: a recorder, a scanner, a video camera and a projector.

10. The mobile device of claim 1, wherein the camera module is further consisted of a plurality of cameras, each capable of working independently for capturing different images.

11. The mobile device of claim 1, wherein in response to the camera module that is detachably received in the selected side of the mobile device for enabling the size of the camera module to be not restricted by the thickness of the mobile device, the detachable camera module is further enabled to be configured with at least one additional component.

12. The mobile device of claim 11, wherein each of the at least one addition component is a component selected from the group consisting of: a flash light, a speaker, a microphone, and a tripod.
